(19) United States
(12) Patent Application Publication
(10) Pub. No.: US 2009/0051687 A1
(43) Pub. Date: Feb. 26, 2009

(54) IMAGE PROCESSING DEVICE

(75) Inventors: Yoshiyuki Kato, Tokyo (JP); Akira Torii, Tokyo (JP); Ryohei Ishida, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/816,576

(22) PCT Filed: Oct. 24, 2006
(86) PCT No.: PCT/JP2006/321152

§ 371 Date: Aug. 17, 2007

(30) Foreign Application Priority Data
Oct. 25, 2005 (JP) 2005-310154

(51) Int. Cl. G06T 15/50

(52) U.S. Cl. 345/426

(57) ABSTRACT

An image processing device includes a shader processor for carrying out a vertex shader process and a pixel shader process successively, a rasterizer unit for generating pixel data required for the pixel shader process on the basis of data on which the vertex shader process has been performed by said shader processor, and a feedback loop for feeding the pixel data outputted from said rasterizer unit back to said shader processor as a target for the pixel shader process which follows the vertex shader process.

### FIELD OF THE INVENTION

The present invention relates to an image processing device which displays a computer graphics image on a display screen. More particularly, it relates to an image processing device which carries out a vertex geometry process and a pixel drawing process programmably.

### BACKGROUND OF THE INVENTION

In general, 3D graphics processing can be grouped into a geometry process of performing a coordinate transformation, a lighting calculation, etc., and a rendering process of decomposing a triangle or the like into pixels, performing texture mapping etc. on them, and drawing them into a frame buffer. In recent years, without using classic geometry processing and rendering processing which are defined beforehand by API (Application Programming Interfaces), photorealistic expression methods using a programmable graphics algorithm have been used. As one of these photorealistic expression methods, there is a vertex shader and a pixel shader (also called a fragment shader). An example of a graphics processor equipped with these vertex shader and pixel shader is disclosed by nonpatent reference 1.

A vertex shader is an image processing program programmed with, for example, assembly language or high-level shading language, and can accelerate an application programmer's own algorithm via hardware. A vertex shader can also perform a movement, a deformation, a rotation, a lighting process, etc. on vertex data freely without changing modeling data. As a result, the graphics processor can carry out 3D morphing, a refraction effect, skinning (a process of smoothly expressing a discontinuous part of a vertex, such as a joint), etc., and can provide a realistic expression without exerting a large load on the CPU.

A pixel shader carries out a programmable pixel arithmetic operation on a pixel-by-pixel basis, and is a program programmed with assembly language or high-level shading language, like a vertex shader. Thereby, a pixel shader can carry out a lighting process on a pixel-by-pixel basis using a normal vector as texture data, and can also carry out a process of performing bump mapping using perturbation data as texture data.

A pixel shader not only can change a calculation method of calculating a texture address, but can perform a blend arithmetic operation of blending a texture color and a pixel programmably. As a result, a pixel shader can also carry out image processing, such as tone reversal and a transformation of a color space. In general, a vertex shader and a pixel shader are used in combination, and various expressions can be provided by combining vertex processing and pixel processing.

In many cases, arithmetic hardware of 4-SIMD type or a special processor like DSP is used as a vertex shader and a pixel shader, and sets of four elements, such as position coordinates [x, y, z, w], colors [r, g, b, a], and texture coordinate [s, t, p, q], are arithmetic-processed in parallel. As the arithmetic format, either a 32-bit floating point format (code:exponent:mantissa=1:8:23) or a 16-bit floating point format (code:exponent:mantissa=1:5:15) is used.

[Nonpatent reference 1] Cem Cebenoyan and Matthias Wloka, “Optimizing the Graphics Pipeline”, GDC 2003 NVIDIA presentation.

The time required for a vertex shader to perform its processing is influenced by the method of computing vertices, the number of light sources, etc. For example, when a transformation is performed on the position information on vertices with displacement mapping or when the number of light sources increases, the time required for the vertex shader to perform its processing increases. On the other hand, the time required for a pixel shader to perform its processing is influenced by the number of pixels included in its primitive and the degree of complexity of the pixel shader arithmetic operation. For example, if there are many pixels included in a polygon or if there are many textures which are sampled by the pixel shader, the time required for the pixel shader to perform its processing increases.

FIG. 8 is a diagram showing the structure of the prior art image processing device disclosed by nonpatent reference 1, and shows, as an example, a graphics processor equipped with a vertex shader and a pixel shader. Assume that in the graphics processor, geometry data (information on vertices which construct an object, information on light sources, etc.) 101a, a command 101b, and texture data 101c are beforehand transferred from a system memory 100 to a video memory 101 in advance of the drawing processing. A storage region is also provided, as a frame buffer 101d, in the video memory 101.

The vertex shader 104 reads required vertex information from a T&L cache 102 disposed in a frontward stage, performs geometrical arithmetic processing, and writes the result of the geometrical arithmetic processing into a T&L cache 105 disposed in a backward stage.

A triangle setup 106 calculates an increment required for the drawing processing etc. by reading three vertex data from the result of the geometrical arithmetic processing written in the backward-stage T&L cache 105. Arasterizer 107 performs a pixel interpolation process on a triangle using the increment so as to decompose the triangle into pixels.

A fragment shader 108 performs a process of reading texel data from a texture cache 103 using texture coordinates generated by the rasterizer 107, and blending the read texel data and color data. Finally, the fragment shader carries out a logical operation (a raster operation) etc. in cooperation with the frame buffer 101d of the video memory 101, and writes a finally-determined color in the frame buffer 101d.

In the structure of the prior art image processing device as shown in FIG. 8, the vertex shader and the pixel shader are implemented as independent processors, respectively. When the processing carried out by the vertex shader and the processing carried out by the pixel shader are kept in balance, they are pipeline-processed efficiently. However, when the image data to be processed is, for example, a small polygon, and the number of pixels included in this polygon is small, the processing carried out by the vertex shader causes a bottleneck to the processing carried out by the pixel shade and therefore the pixel shader enters an idle state frequently. In contrast with this, when the image data to be processed is a large polygon, and the number of pixels included in this polygon is large, the processing carried out by the pixel shader causes a bottleneck to the processing carried out by the vertex shade and therefore the vertex shader enters an idle state frequently.

General-purpose applications have an imbalanced relation between the vertex processing and the pixel processing, and have a large tendency of only one of loads caused by them to become large. For example, it has been reported that, for an application intended for mobile phones, when comparing a case in which the vertex processing and the pixel processing are pipeline-processed with a case in which the vertex processing and the pixel processing are not pipeline-processed, the processing performance was improved by only about 10%.

In many cases, each of the vertex shader and the pixel shader is equipped with an FPU of 4-SIMD type, their hardware scales are quite large. The fact that either one of the shaders enters an idle state nevertheless means that the mounted arithmetic hardware is not running efficiently and this is equivalent to mounting of useless hardware. Particularly, this causes a big problem in a field in which the image processing device is intended for incorporation into another device and there is a necessity to reduce its hardware scale. Furthermore, an increase in the gate scale also increases the power consumption.

The present invention is made in order to solve the above-mentioned problems, and it is therefore an object of the present invention to provide an image processing device which can remove the imbalance between the processing load of a vertex shader and that of a pixel shader, and which can make the vertex shader and the pixel shader carry out their processes efficiently.

### DISCLOSURE OF THE INVENTION

In accordance with the present invention, there is provided an image processing device including a shader processor for carrying out a vertex shader process and a pixel shader process successively, a rasterizer unit for generating pixel data required for the pixel shader process on the basis of data on which the vertex shader process has been performed by the shader processor, and a feedback loop for feeding the pixel data outputted from the rasterizer unit back to the shader processor as a target for the pixel shader process which follows the vertex shader process.

Because the image processing device in accordance with the present invention includes the shader processor for carrying out the vertex shader process and the pixel shader process successively, the rasterizer unit for generating pixel data required for the pixel shader process on the basis of data on which the vertex shader process has been performed by the shader processor, and the feedback loop for feeding the pixel data outputted from the rasterizer unit back to the shader processor as a target for the pixel shader process which follows the vertex shader process, the image processing device carries out successively the vertex shader process and the pixel shader process by using the same processor. Therefore, the present invention provides an advantage of being able to remove the imbalance between the processing load of the vertex shader and that of the pixel shader, and to carry out the vertex shader process and the pixel shader process efficiently.

### BRIEF DESCRIPTION OF THE FIGURES

FIG. 1 is a block diagram showing the structure of an image processing device in accordance with embodiment 1 of the present invention;

FIG. 2 is a diagram for explaining the structure and the operation of a shader core of an image processing device in accordance with embodiment 2 of the present invention;

FIG. 3 is a diagram showing an example of 3D graphics processing carried out by the image processing device in accordance with the present invention;

FIG. 4 is a diagram showing an example of arrangement of programs in the shader core of the image processing device in accordance with the present invention;

FIG. 5 is a diagram showing the structure of computing units included in a shader core of an image processing device in accordance with embodiment 3 of the present invention;

FIG. 6 is a diagram showing an example of an instruction format in accordance with embodiment 3;

FIG. 7 is a block diagram showing the structure of an image processing device in accordance with embodiment 4 of the present invention; and

FIG. 8 is a diagram showing the structure of a prior art image processing device shown in nonpatent reference 1.

### PREFERRED EMBODIMENTS OF the Invention

Hereafter, in order to explain this invention in greater detail, the preferred embodiments of the present invention will be described with reference to the accompanying drawings.

### Embodiment 1

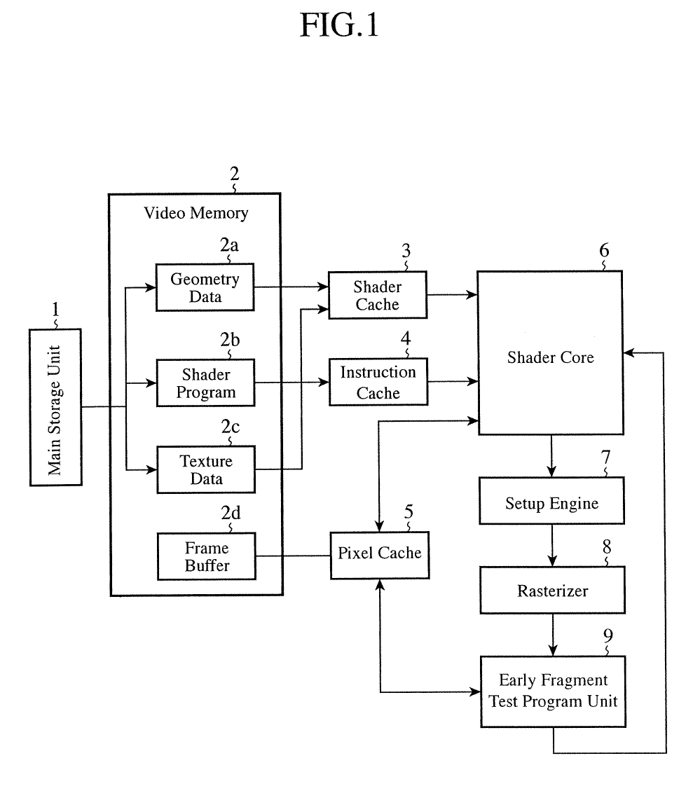

FIG. 1 is a block diagram showing the structure of an image processing device in accordance with embodiment 1 of the present invention. The image processing device in accordance with this embodiment 1 is provided with a main storage unit 1, a video memory 2, a shader cache (cache memory) 3, an instruction cache (cache memory) 4, a pixel cache (cache memory) 5, a shader core 6, a setup engine 7, a rasterizer (rasterizer unit) 8, and an early fragment test program unit (fragment test unit) 9. The main storage 1 stores geometry data 2a including vertex information which constructs an image, such as an image of an object which is a target for drawing processing, and information (data for lighting calculation) about light, including the illuminance of each light source and so on, a shader program 2b for making a processor of this image processing device operate as the shader core 6, and texture data 2c.

The video memory 2 is a storage unit intended only for the image processing, and the geometry data 2a, the shader program 2b, and the texture data 2c are beforehand transferred from the main storage unit 1 prior to the image processing of this image processing device. A storage region in which pixel data on which a final arithmetic operation has been performed are written from the pixel cache 5 as deemed appropriate is disposed in the video memory 2, and is used as a region of the frame buffer 2d. The video memory 2 and the main storage 1 can be constructed of a single memory.

The geometry data 2a and the texture data 2c are read from the video memory 2, and are written into and held by the shader cache (cache memory) 3. At the time of the image processing by the shader core 6, the data stored in this shader cache 3 are properly read out and sent to the shader core 6, and are used for that processing. An instruction required to make the shader core 6 operate is read out of the shader program 2b of the video memory 2, and is held by the instruction cache (cache memory) 4. The instruction of the shader program 2b is then read and sent to a shader processor via the instruction cache 4, and is executed by the shader processor, so that the shader processor runs as the shader core 6. Destination data of the video memory 2 stored in the frame buffer 2d is held by the pixel cache (cache memory) 5, and is sent to the shader core 6. The final pixel value on which an arithmetic operation has been performed is then held by the pixel cache and is written into the frame buffer 2d.

The shader core 6 is constructed of the single shader processor which executes the instruction of the shader program 2b read out via the instruction cache 4, reads the data required for the image processing via the shader cache 3 and the pixel cache 5, and carries out sequentially both a process about a vertex shader and a process about a pixel shader. The setup engine 7 calculates an increment required for interpolation from primitive vertex information outputted from the shader core 6.

The rasterizer (rasterizer unit) 8 decomposes a triangle determined by the vertex information into pixels while judging whether each pixel is located inside or outside the triangle, and carries out interpolation using the increment calculated by the setup engine 7. The early fragment test program unit (fragment test unit) 9 is disposed on a feedback loop between the rasterizer 8 and the shader core 6, compares the depth value of each pixel which is calculated by the rasterizer 8 with the depth value of the destination data read out of the pixel cache 5, and judges whether to feed the pixel value back to the shader core 6 according to the comparison result.

Next, the operation of the image processing device in accordance with this embodiment of the present invention will be explained.

Prior to the drawing processing, geometry data 2a including vertex information which constructs an image of an object which is to be drawn, information about light from each light source, the shader program 2b for making the processor operate as the shader core 6, and texture data 2c are beforehand transferred from the main storage unit 1 to the video memory 2.

The shader core 6 reads the geometry data 2a which is the target to be processed from the video memory 2 via the shader cache 3, and carries out a vertex shader process, such as a geometrical arithmetic operation using the geometry data 2a and a lighting arithmetic operation. At this time, the shader core 6 reads each instruction of the shader program 2b about the vertex shader from the video memory 2 via the instruction cache 4, and runs. Because each instruction of the shader program 2b is successively stored in the instruction cache 4 which is an external memory, a maximum number of steps of each instruction is not limited.

After carrying out the vertex shader process, the shader core 6 carries out a culling process, a viewport conversion process, and a primitive assembling process, and outputs, as process results, primitive vertex information calculated thereby to the setup engine 7. The culling process is a process of removing the rear face of a polyhedron, such as a polygon defined by the vertex data, from the target to be drawn. The viewport conversion process is a process of converting the vertex data into data in a device coordinate system. The primitive assembling process is a process of reconstructing a triangle combined in a series, like a strip, a triangle which shares one vertex, like a fan, or the like into an independent triangle.

Thus, because the shader core 6 is so constructed as to also carry out the processes other than the vertex shader process successively, fixed processing hardware which carries out the processes other than the vertex shader process can be omitted. Therefore, the image processing device can carry out the processes integratedly.

The setup engine 7 calculates the on-screen coordinates of each pixel which constructs a polygon from the primitive vertex information outputted from the shader core 6 and color information on each pixel, and calculates an increment of the coordinates and an increment of the color information. The calculated increments are then outputted from the setup engine 7 to the rasterizer 8. The rasterizer 8 decomposes a triangle determined by the vertex information into pixels while judging whether each pixel is located inside or outside the triangle, and carries out interpolation using the increments calculated by the setup engine 7. The judgment of whether each pixel is located inside or outside a triangle is carried out by, for example, evaluating a straight line's equation indicating the triangle's side for each pixel which can be located inside the triangle, and by judging whether or not a target pixel is located inside the triangle's side.

The early fragment test program unit 9 compares the depth value of a pixel (source) which is going to be drawn from now on, the depth value being calculated by the rasterizer 8, with the depth value in the destination data (display screen) of a pixel which is previously read out of the pixel cache 5. At this time, if the comparison result shows that the depth value of the pixel which is going to be drawn falls within its limit in which drawing of pixels should be permitted, the early fragment test program unit feeds the data about the pixel which is going to be drawn because it has been assumed to pass the test back to the shader core 6 so that the shader core can carry out the drawing processing. In contrast, unless the comparison result shows that the depth value of the pixel which is going to be drawn does not fall within the limit, because the early fragment test program unit judges that it has failed the test and therefore does not need to draw the pixel, the early fragment test program unit does not output the pixel data to the shader core 6 located therebehind.

Next, the shader core 6 carries out the pixel shader process by using the texture data 2c read out of the video memory 2 via the shader cache 3, and the pixel value inputted thereto from the early fragment test program unit 9. At this time, the shader core 6 reads each instruction of the shader program 2b about the pixel shader from the video memory 2 via the instruction cache 4, and runs.

Next, after carrying out the pixel shader process, the shader core 6 reads the destination data from the frame buffer 2d via the pixel cache 5, and then carries out an alpha blend process and a raster operation process. The alpha blend process is a process of carrying out a translucence composition of two images using alpha values. The raster operation process is a process of super imposing an image on another image, for example, a process of superimposing each pixel of the target to be drawn on a corresponding pixel of the destination data which is a background to each pixel of the target to be drawn.

Thus, because the shader core 6 is so constructed as to also carry out the processes other than the vertex shader process successively, fixed processing hardware which carries out the processes other than the vertex shader process can be omitted. Therefore, the image processing device can carry out the processes integratedly. Each final pixel value which is thus computed as mentioned above is written into the frame buffer 2d via the pixel cache 5 by the shader core 6.

As mentioned above, in accordance with this embodiment 1, a feedback loop which feeds the output of the rasterizer 8 back to the shader processor is disposed so that the shader core 6 which carries out the vertex shader process and the pixel shader process sequentially is constructed of a single shader processor. Therefore, the processor can be prevented from entering an idle state, whereas, conventionally, two graphics processors which are disposed independently for the vertex shader process and the pixel shader process cannot be prevented from entering an idle state. As a result, the power consumption can be reduced and the hardware scale can also be reduced.

In accordance with above-mentioned embodiment 1, the early fragment test program unit 9 is disposed on the feedback loop between the rasterizer 8 and the shader core 6, as previously explained. As an alternative, the shader core 6 can be so constructed as to have the functions of the early fragment test program unit 9, so that the early fragment test program unit 9 can be eliminated.

### Embodiment 2

An image processing device in accordance with this embodiment 2 is so constructed as to prefetch data from the rasterizer to the shader cache and the pixel cache by using an FIFO (First In First Out) for data transfer from the rasterizer to the shader core.

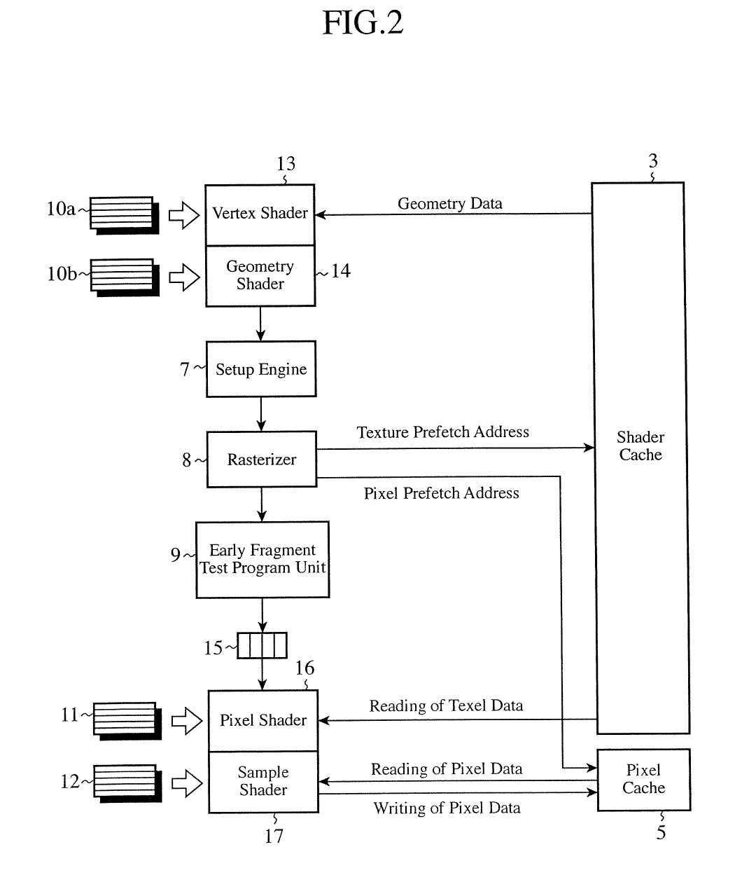

FIG. 2 is a diagram for explaining the structure and the operation of a shader core of the image processing device in accordance with embodiment 2 of the present invention. In this image processing device, the FIFO 15 is disposed between the early fragment test program unit 9 which accepts the output of the rasterizer 8 and the pixel shader 16, in the structure of above-mentioned embodiment 1. In the figure, the shader core 6 is shown by a combination of a vertex shader 13, a geometry shader 14, a pixel shader 16, and a sample shader 17 in order to explain its functions, though the shader core 6 is actually constructed of a single shader processor which carries out the processes of these shaders integratedly.

The vertex shader 13 carries out a vertex shader process using a resource 10a. The geometry shader 14 carries out a geometry shader process using a resource 10b. The pixel shader 16 carries out a pixel shader process using a resource 11. The sample shader 17 carries out a sample shader process using a resource 12. For example, as the resources 10a, 10b, 11, and 12, data registers disposed in the shader processor, internal registers like address registers, or program counters can be used. In FIG. 2, the same components as shown in FIG. 1 or like components are designated by the same numerals, and the repeated explanation of the components will be omitted hereafter.

Next, the operation of the image processing device in accordance with this embodiment of the present invention will be explained.

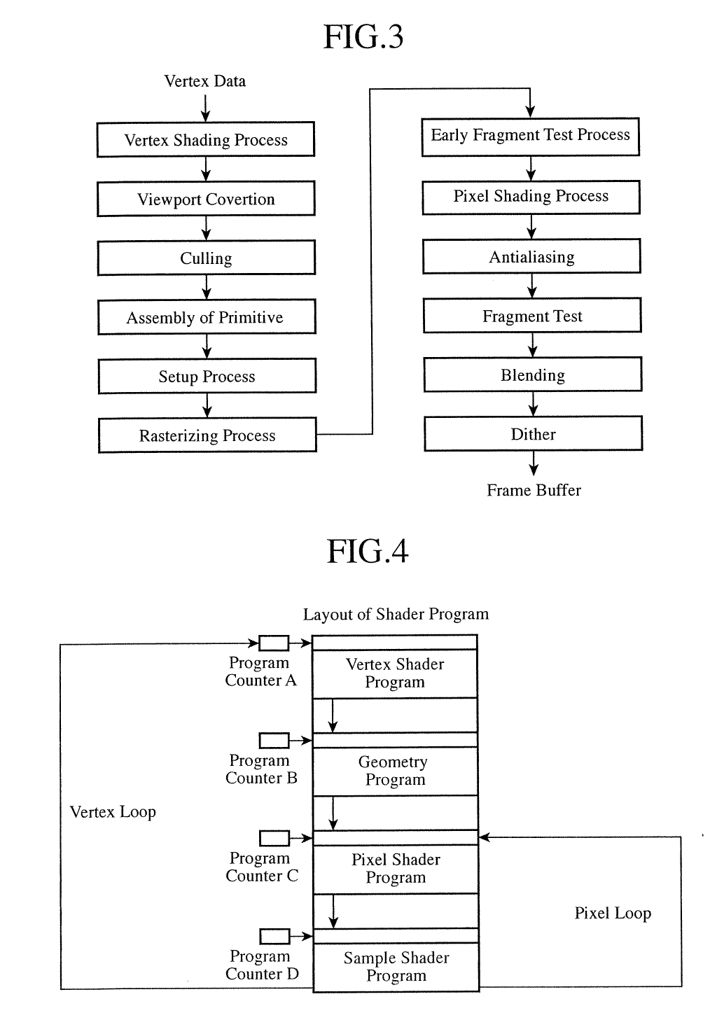

FIG. 3 is a diagram showing an example of 3D graphics processing carried out by the image processing device in accordance with the present invention. Because the image processing device in accordance with embodiment 2 has the same structure as that of above-mentioned embodiment 1 fundamentally, the operation of the image processing device will be explained with reference to FIGS. 1 and 3. The vertex shader 13 reads vertex data from the video memory 2 via the shader cache 3, and carries out the vertex shading process. At this time, the resource 10a used for the vertex shader 13 is used as the resource including the internal registers of the shader core 6 (a data register, an address register, etc. disposed in the processor) and program counters.

Next, after completing the vertex shading process by using the vertex shader 13, the image processing device shifts to the process using the geometry shader 14. The geometry shader 14 successively carries out viewport conversion, a culling process, and a primitive assembling process which are explained in above-mentioned embodiment 1. In performing this process using the geometry shader 14, the resource of the shader core 6 including internal registers and program counters changes from the resource 10a to the resource 10b used for the geometry shader 14. Thus, because different resources are used by the vertex shader 13 and the geometry shader 14, the geometry shader program can be executed without being dependent upon the exit status of the vertex shader program, and can be described as an independent program.

When the process by the geometry shader 14 is completed, the shader core 6 outputs the results of the operation to the setup engine 7. The setup engine 7 calculates the on-screen coordinates of each pixel which constructs a polygon from the primitive vertex information outputted from the shader core 6 and color information on each pixel, and calculates an increment of the coordinates and an increment of the color information, like that of above-mentioned embodiment 1. The calculated increments are outputted from the setup engine 7 to the rasterizer 8. The rasterizer 8 decomposes a triangle determined by the vertex information into pixels (creates fragments) while judging whether each pixel is located inside or outside the triangle, and carries out interpolation using the increments calculated by the setup engine 7.

The pixel information calculated by the rasterizer 8 is outputted to the early fragment test program unit 9. The early fragment test program unit 9 compares the depth value of a pixel (fragment) which is going to be drawn from now on, the depth value being calculated by the rasterizer 8, with the depth value in the destination data of a pixel which is previously read out of the pixel cache 5. At this time, if the comparison result shows that the depth value of the pixel which is going to be drawn falls within its limit in which drawing of pixels should be permitted, the early fragment test program unit outputs the pixel data about the pixel which is going to be drawn because it has been assumed to pass the test to the FIFO 15. In contrast, unless the comparison result shows that the depth value of the pixel which is going to be drawn does not fall within the limit, because the early fragment test program unit judges that it has failed the test and therefore does not need to draw the pixel, the early fragment test program unit does not output the pixel data to the FIFO 15 located therebehind.

Simultaneously, the rasterizer 8 outputs, as a pixel prefetch address, the XY coordinates of the pixel which has been outputted to the FIFO 15 to the pixel cache 5. The pixel cache 5 prefetches the pixel data on the basis of the coordinates. Because the image processing device operates in this way, when using desired pixel data written into the frame buffer 2d later, the pixel cache 5 can carry out reading and writing of the data without erroneously hitting wrong data. Simultaneously, the rasterizer 8 outputs, as a texture prefetch address, texture coordinates to the shader cache 3. The shader cache 3 prefetches texel data on the basis of the coordinates.

By thus storing pixel data and texture data in the FIFO 15 temporarily, and by prefetching pixels and texel data using the pixel cache 5 and the shader cache 3, when actually using the pixels and the texel data, the image processing device can prepare the data beforehand in the pixel cache 5 and the shader cache 3, and therefore can reduce the read latency from the caches to a minimum.

The pixel shader 16 performs an arithmetic operation about the pixel shading process using the pixel information read out of the FIFO 15 and the texel data read out of the shader cache 3. At this time, the resource 11 used for the pixel shader 16 is used as the resource of the shader processor including internal registers and program counters.

When the process of the pixel shader 16 is completed, the sample shader 17 carries out successively an antialiasing process, a fragment test process, a plending process, and a dithering process on the basis of the results of the operation by the pixel shader 16. At this time, the resource of the shader core including internal registers and program counters changes from the resource 11 to the resource 12 used for the sample shader 17. Thus, because different resources are used by the pixel shader 16 and the sample shader 17, the sample shader program can be executed without being dependent upon the exit status of the pixel shader program, and can be described as an independent program.

The antialiasing process is a process of calculating a coverage value so as to show the jaggies of an edge smoothly. The blending process is a process of performing a translucence process such as alpha blending. The dithering process is a process of adding dither in a case of a small number of color bits. The fragment test process is a process of judging whether to draw a pixel which is obtained as a fragment to be drawn, and includes an alpha test, a depth test (hidden-surface removal), and a stencil test. In performing these processes, when the destination data in the frame buffer 2d are needed, the pixel data (the color value, the depth value, and the stencil value) are read by the sample shader 17 via the pixel cache 5.

The alpha test is a process of comparing the alpha value of a pixel (fragment) to be written in with the alpha value of a pixel read out of the pixel cache 5 which is used as a reference, and determining whether to draw the pixel according to a specific comparison function. The depth test (hidden-surface removal) is a process of comparing the depth value of a pixel (fragment) to be written in with the depth value of a pixel read out of the pixel cache 5 which is used as a reference, and determining whether to draw the pixel according to a comparison function. The stencil test is a process of comparing the stencil value of a pixel (fragment) to be written in with the stencil value of a pixel read out of pixel cache 5 which is used as a reference, and determining whether to draw the pixel according to a comparison function.

The pixel data on which an arithmetic operation has been performed by the sample shader 17 are written into the pixel cache 5, and are also written into the frame buffer 2d of the video memory 2 via the pixel cache 5.

Although the programs of the vertex shader 13 and the pixel shader 16 can be described by an application programmer, because the processes of the geometry shader 14 and the sample shader 17 are fixed ones described by the device driver side, they are not opened to any application programmer in many cases.

As mentioned above, because the image processing device in accordance with this embodiment 2 carries out the process of each shader using a resource specific to the process, the image processing device does not need to take the management of the resource for use in each shader program into consideration and can execute two or more processing programs efficiently on the single processor. The image processing device also stores pixel information in the FIFO 15 temporarily, and prefetches pixels and texel data by using the pixel cache 5 and the shader cache 3. Thereby, when actually using the pixels and the texel data, the image processing device can prepare the data beforehand in the pixel cache 5 and the shader cache 3, and can prevent any delay from occurring due to the latency time. That is, the read latency from the caches can be reduced to a minimum.

FIG. 4 is a diagram showing an example of arrangement of programs of the shader core in the image processing device in accordance with the present invention, and the shader program is comprised of a vertex shader program, a geometry program, a pixel shader program, and a sample program. These programs correspond to the program of the vertex shader 13, that of the geometry shader 14, that of the pixel shader 16, and that of the sample shader 17 as shown in FIG. 2, respectively. These programs do not need to be arranged in order, and can be arranged in a random fashion and at arbitrary addresses.

First, the vertex shader program starts its execution from an instruction which is specified by a program counter A. When the process of the vertex shader is completed, the program counter changes from the program counter A to a program counter B, and an instruction of the geometry program which is specified by the program counter B is then executed. After that, by similarly performing a switching between program counters, the image processing device sequentially executes an instruction of the pixel shader program and an instruction of the sample shader program.

The vertex shader program and the geometry program are processed on a primitive-by-primitive step. On the other hand, the pixel shader program and the sample shader program are processed on a pixel-by-pixel basis. For this reason, for example, while pixels (fragments) included in a triangle are generated, the pixel shader program and the sample shader program are repeatedly executed only a number of times corresponding to the number of the pixels. That is, the pixel shader program and the sample shader program are repeatedly executed while a switching between a program counter C and a program counter D is done. After all processes are completed for all the pixels included in the triangle, the program counter is changed to the program counter A again, and the vertex shader program is executed for the next vertex.

Thus, the image processing device can execute the shader program stored at an arbitrary address on the single processor by changing the program counter among the shaders. Furthermore, the image processing device can prepare two or more shader programs beforehand, and can selectively execute one of these shader programs properly in response to a request from the application, according to the drawing mode, or the like.

### Embodiment 3

An image processing device in accordance with this embodiment 3 is so constructed as to carry out processes efficiently using computing units of the shader core which are configured to suit to each shader program by dynamically reconfigurating both the configuration of the computing units and the instruction set.

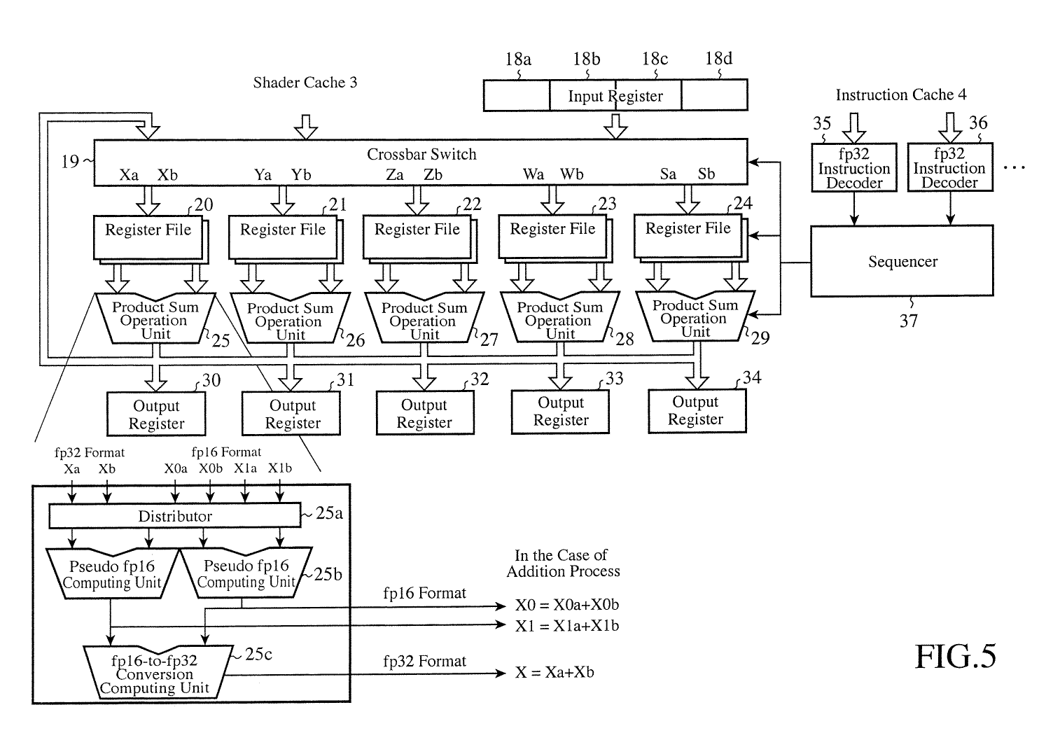

FIG. 5 is a diagram showing the structure of the computing units included in the shader core of the image processing device in accordance with embodiment 3 of the present invention. In the figure, the shader core 6 in accordance with embodiment 3 is provided with input registers 18a to 18d, a crossbar switch 19, register files 20 to 24, product sum operation units (computing units) 25 to 28, a scalar operation unit (computing unit) 29, output registers 30 to 34, an fp32 instruction decoder (instruction decoder) 35, an fp16 instruction decoder (instruction decoder) 36, and a sequencer 37.

For example, when the position coordinates of a pixel is processed, data on the position coordinates X, Y, Z, and W of the pixel outputted from another image block is stored in the input registers 18a, 18b, 18c, and 18d, respectively. In a case in which a color image is processed, color data R, G, B and A are stored in the input registers 18a, 18b, 18c, and 18d, respectively. When texture coordinates are processed, texture coordinate S, T, R, and Q are data held by the input registers 18a, 18b, 18c, and 18d, respectively. Arbitrary scalar data may be stored in the input registers.

The crossbar switch 19 arbitrarily selects the outputs of the input registers 18a to 18d, data from the shader cache 3, or the outputs of the product sum operation units 25 to 28 and the scalar operation unit 29 according to a control signal from the sequencer 37, and outputs the selected outputs to the register files 20 to 24, respectively. Data other than scalar data from the input registers 18a to 18d or the shader cache 3 or the output values of the product sum operation units 25 to 28, which have been selected by the crossbar switch 19, are stored in the register files 20 to 23. Scalar data from the input registers 18a to 18d or the shader cache 3, or the output value of the scalar operation unit 29, which has been selected by the crossbar switch 19, is stored in the register file 24.

The product sum operation units 25 to 28 perform product sum operations on the data inputted thereto from the register files 20 to 23, and output the results of the operations to the output registers 30 to 33, respectively. By using these four product sum operation units 25 to 28, the shader core can perform an arithmetic operation in the 4-SIMD format. That is, the shader core can implement the arithmetic operation on the position coordinates (X, Y, Z, W) of a vertex at a time.

The scalar operation unit 29 performs a scalar operation process on the scalar data (expressed as Sa and Sb in the figure) inputted thereto from the register file 24, and outputs the results of the operation to the output register 34. In this case, the scalar operation performed by the scalar operation unit 29 is a special arithmetic operation, such as a division, a calculation of a power, or a calculation of sin/cos which is an arithmetic operation other than a calculation of a sum of products. The output registers 30 to 34 temporarily store the results of the operations of the computing units, and output them to the pixel cache 5 or the setup engine 7.

Hereafter, the internal structure of each product sum operation unit will be explained. For example, the product sum operation unit 25 includes a distributor 25a, two pseudo 16-bit computing units (abbreviated as pseudo fp16 computing units in the figure) (arithmetic units) 25b, and a 16-to-32-bit conversion computing unit (abbreviated as an fp16-to-fp32 conversion computing unit in the figure) (conversion unit) 25c. When the compute mode specified by a control signal from the sequencer 37 is 32-bit compute mode, the distributor 25a divides operation data in the 32-bit format into two upper and lower data in the 16-bit format, and outputs them to the two pseudo 16-bit computing units 25b, respectively.

Each pseudo 16-bit computing unit 25b carries out a computation in the pseudo 16-bit format (code:exponent:mantissa=1:8:15), and outputs data in the fp16 bit format. The 16-to-32-bit conversion computing unit 25c converts the two upper and lower data in the pseudo 16-bit format into data in the 32-bit floating point format (code:exponent:mantissa=1:8:23).

The fp32 instruction decoder 35 decodes an instruction code for making the shader code run with 4-SIMD (Single Instruction/Multiple Data) using the 32-bit floating point format. The fp16 instruction decoder decodes an instruction code for making the shader core run with 8-SIMD using the 16-bit floating point format. The sequencer 37 outputs a control signal to the crossbar switch 19, the register files 20 to 24, the product sum operation units 25 to 28, and the scalar operation unit 29 according to a request from either the fp32 instruction decoder 35 or the fp16 instruction decoder 36.

Next, the operation of the image processing device in accordance with this embodiment of the present invention will be explained.

When the instruction code read out of the instruction cache 4 is an instruction code (an fp32 instruction) for making the shader code run with 4-SIMD using the 32-bit floating point format, the fp32 instruction decoder 35 decodes the instruction code and outputs a request according to the instruction to the sequencer 37. In contrast, when the instruction code read out of the instruction cache 4 is an instruction code (an fp16 instruction) for making the shader code run with 8-SIMD using the 16-bit floating point format, the fp16 instruction decoder 36 decodes the instruction code and outputs a request according to the instruction to the sequencer 37.

The sequencer 37 outputs a control signal to the crossbar switch 19, the register files 20 to 24, the product sum operation units 25 to 28, and the scalar operation unit 29 according to the request inputted from either the fp32 instruction decoder 35 or the fp16 instruction decoder 36. For example, assume that position coordinates (Xa, Ya, Za, Wa) and position coordinates (Xb, Yb, Zb, Wb) are outputted as data from the registers 18a, 18b, 18c, and 18d to the crossbar switch 19. In this case, when the request inputted from either the fp32 instruction decoder 35 or the fp16 instruction decoder 36 is a request for the addition process, the sequencer 37 outputs the control signal to the crossbar switch 19, and makes it output the position coordinates (Xa, Ya, Za, Wa) and (Xb, Yb, Zb, Wb) to the register files 20 to 23, respectively.

The sequencer 37 further controls the register files 20 to 23 so as to make them output data according to either the 16-bit add operation mode or the 32-bit add operation mode to the product sum operation units 25 to 28. For example, in the case of the 32-bit add operation mode, the register file 20 outputs the coordinates Xa and Xb in the 32-bit format to the product sum operation unit 25. In contrast, in the case of the 16-bit add operation mode, from the coordinates Xa and Xb in the 32-bit format, the register file 20 generates upper and lower data X0a and X1a divided in the 16-bit format and upper and lower data X0b and X1b divided in the 16-bit format, respectively, and outputs them to the product sum operation unit 25.

In the 16-bit add operation mode, the distributor 25a outputs the data X0a and X0b among the data X0a, X1a, X0b, and X1b which are inputted from the register file 20, to one pseudo 16-bit computing unit 25b, and outputs the other data X1a and X1b to the other pseudo 16-bit computing unit 25b. Thereby, the two pseudo 16-bit computing units 25b simultaneously perform add operations on them in the 16-bit floating point format (code:exponent:mantissa=1:5:15), respectively, and output X0=X0a+X0b and X1=X1a+X1b to the output register 30 as the two add operation results in the 16-bit format.

On the other hand, in the 32-bit floating point mode, the distributor 25a divides each of the coordinates Xa and Xb in the 32-bit format to two upper and lower data in the 16-bit format, and outputs them to the two pseudo 16-bit computing units 25b, respectively. The two pseudo 16-bit computing units 25b perform the add operations on the inputted data, and output them to the 16-to-32-bit conversion computing unit 25c. The 16-to-32-bit conversion computing unit 25c converts the upper and lower results of the operations in the pseudo 16-bit format outputted from the two pseudo 16-bit computing units into one data in the 32-bit format, and outputs X=Xa+Xb to the output register 30 as its operation result in the 32-bit format. The product sum operation units 26, 27, and 28, and the scalar operation unit 29 perform an arithmetic operation in the same manner.

Thus, by using the two or more instruction decoders and the computing units corresponding to them, the shader core can reconfigurate the configuration of the computing units according to the arithmetic format, and can carry out efficiently arithmetic operations with different arithmetic formats. For example, by dynamically switching between an fp32 instruction and an fp16 instruction, the shader code can switch between a 32-bit floating-point arithmetic operation based on 4-SIMD and a 16-bit floating-point arithmetic operation based on 8-SIMD properly to suit the process.

Generally, in many cases, the vertex shader process is carried out in the 32-bit floating point format, whereas the pixel shader process is carried out in the 16-bit floating point format. Therefore, if the vertex shader process is carried out according to fp32 instructions and the pixel shader process is carried out according to fp16 instructions, these processes can be carried out as a sequence of processes. As a result, the image processing device can make the utmost effective use of the hardware operation resource required for the execution of the vertex shader process and the pixel shader process, and can also reduce the word length of instructions.

Furthermore, by changing the instruction format dynamically, not only as to the arithmetic format but also as to the types of operation instructions, the image processing device can prepare an optimal instruction set for each of the vertex shader process, the geometry shader process, the pixel shader process, and the sample shader process.

For example, in the vertex shader process, there is a tendency to heavily use 4×4 matrix operations, and in the pixel shader process, there is a tendency to heavily use linear interpolation operations required of filtering etc., as will be mentioned below.

### (1) Matrix Arithmetic Operation

X=M00*A+M01*B+M02*C+M03*D

Y=M10*A+M11*B+M12*C+M13*D

Z=M20*A+M21*B+M22*C+M23*D

W=M30*A+M31*B+M32*C+M33*D

where M00 to M33 are elements of a 4×4 matrix.

### (2) Linear Interpolation Process

Interpolated value C=Arg0*Arg2+Arg1*(1−Arg2)

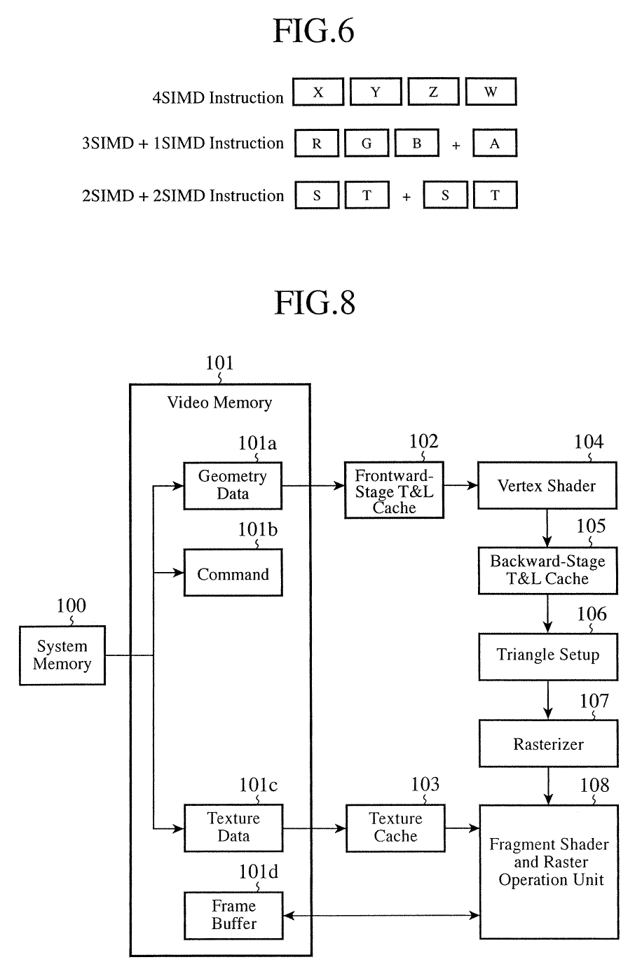

For example, as an operation on the position coordinates (X, Y, Z, W) in the vertex shader process, a 4×4 matrix operation is performed on the components (X, Y, Z, W) at a time. A 4SIMD instruction in an instruction format which makes the shader code perform an arithmetic operation based on 4-SIMD is used for the components (X, Y, Z, W) shown in the top row of FIG. 6.

As color operations in the pixel shader process, different operations are performed on the components (R, G, B) and the component (A), respectively, in many cases. Therefore, as shown in the middle row of FIG. 6, an instruction format which makes the shader core perform an arithmetic operation based on a combination of 3-SIMD and 1-SIMD can be used.

On the other hand, when computing a texture address, it is preferable that the shader code computes (S0, T0) components and (S1, T1) component simultaneously, as in the case of a multi texture, and an instruction format which makes the shader core perform an arithmetic operation based on a combination of 2-SIMD and 2-SIMD is more efficient as shown in the bottom row of FIG. 6.

As mentioned above, in the image processing device in accordance with this embodiment 3, because the shader core 6 is constructed of the processor including the fp32 instruction decoder 35 for decoding an instruction code which specifies an arithmetic operation in the 32-bit arithmetic format, the fp16 instruction decoder 36 for decoding an instruction code which specifies an arithmetic operation in the 16-bit arithmetic format, the plurality of computing units 25 to 29 each having the two pseudo 16-bit computing units 25b and the 16-to-32-bit conversion computing unit 25c for converting data in the 16-bit arithmetic format into data in the 32-bit arithmetic format, for computing data in an arithmetic format which corresponds to each instruction code by performing arithmetic format conversion on an arithmetic operation by one computing unit 25b or the result of the arithmetic operation by using the 16-to-32-bit conversion computing unit 25c, the crossbar switch 19 for inputting data required for the shader process and for selecting data on which each of the computing units 25 to 29 will perform an arithmetic operation from the input data, and the sequencer 37 for controlling the arithmetic operations which are performed on the data in the arithmetic format according to each instruction code by the computing units 25 to 29, by determining the data selection by the crossbar switch 19 and determining a combination of internal computing units of the arithmetic operation units 25 to 29 which perform the arithmetic operations on the data according to the instruction decoded by either the fp32 instruction decoder 35 or the fp16 instruction decoder 36. Therefore, the image processing device can prepare operation instructions which are used frequently among the shaders, and can change the degree of parallelism of arithmetic operations according to the use of the image processing device. As a result, the image processing device can carry out efficiently arithmetic operations with different arithmetic formats. Furthermore, the image processing device can carry out an optimal process efficiently on the same hardware. In addition, the image processing device can select an optimal instruction set according to a graphics API which it handles by changing the instruction format dynamically.

### Embodiment 4

An image processing device in accordance with this embodiment 4 includes, as integrated shader pipelines, a plurality of sets of main components of the image processing device in accordance with either of above-mentioned embodiments 1 to 3 which are made to operate in parallel with one another, thereby improving its image processing performance.

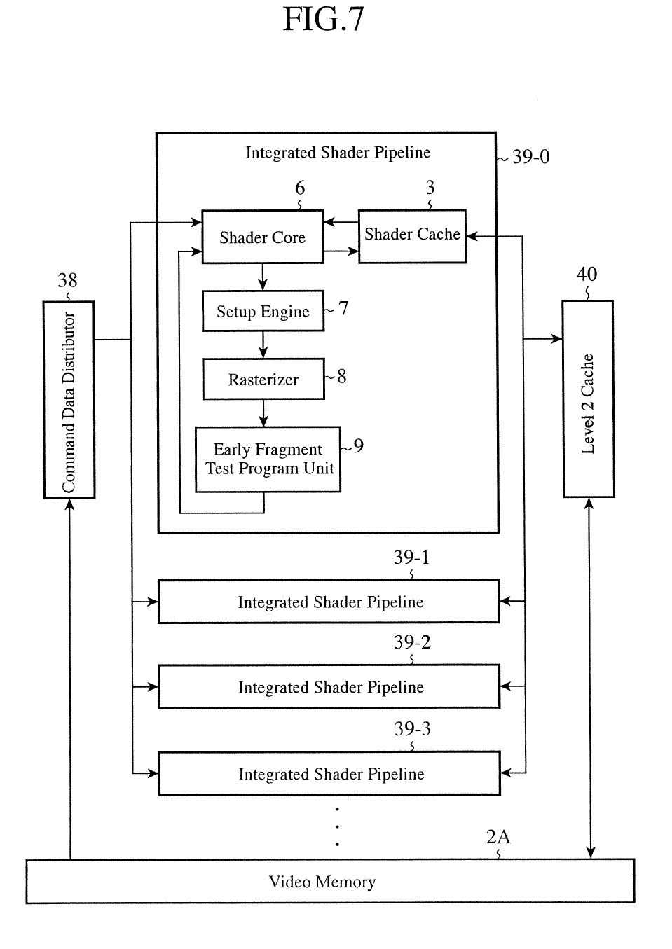

FIG. 7 is a figure showing the structure of the image processing device in accordance with embodiment 4 of the present invention. In the figure, the integrated shader pipelines 39-0, 39-1, 39-2, 39-3, and are arranged in parallel with one another, and each of them includes a shader cache 3, a shader core 6, a setup engine 7, a rasterizer 8, and an early fragment test program unit 9. The basic operations of these components are the same as those explained in above-mentioned embodiment 1. The shader cache 3 also has the functions of the pixel cache 5 shown in above-mentioned embodiment 1, and stores pixel data finally acquired through arithmetic operations performed by the shader core 6.

A video memory 2A is disposed in common to the integrated shader pipelines 39-0, 39-1, 39-2, 39-3, and . . . . A command data distributor 38 reads instructions of the shader program and vertex data of geometry data which are stored in the video memory 2A, and distributes them to the shader cores 6 of the integrated shader pipelines 39-0, 39-1, 39-2, 39-3, and . . . . A level 2 cache 40 temporarily holds pixel data which are operation results obtained by the integrated shader pipelines 39-0, 39-1, 39-2, 39-3, and . . . , and transfers them to a frame buffer region disposed in the video memory 2A.

Next, the operation of the image processing device in accordance with this embodiment of the present invention will be explained. Prior to the drawing processing, geometry data including vertex information about vertices which construct an image of an object to be drawn, and information about light from light sources, a shader program which makes the processor operate as the shader core 6, and texture data are beforehand transferred from a not-shown main storage unit to the video memory 2A.

The command data distributor 38 reads vertex data included in a scene stored in the video memory 2A, and decomposes the vertex data into data in units of, for example, triangle strips or triangle fans, and transfers them, as well as an instruction code (command) of the shader program, to the shader cores 6 of the integrated shader pipelines 39-0, 39-1, 39-2, 39-3, . . . in turn. At this time, if a destination integrated shader pipeline is in a busy state, the command data distributor 38 transfers the data to the next integrated shader pipeline in an idle state. Thereby, each integrated shader pipeline s shader core 6 carries out the vertex shader process, such as a geometrical arithmetic operation using geometry data and a lighting arithmetic operation.

In each integrated shader pipeline, the shader core 6, after carrying out the vertex shader process, carries out a culling process, a viewport conversion process, and a primitive assembling process, and outputs, as process results, primitive vertex information calculated thereby to the setup engine 7, like that of above-mentioned embodiment 1.

The setup engine 7 calculates the on-screen coordinates of each pixel which constructs a polygon from the primitive vertex information outputted from the shader core 6 and color information on each pixel, and calculates an increment of the coordinates and an increment of the color information. The rasterizer 8 decomposes a triangle determined by the vertex information into pixels while judging whether each pixel is located inside or outside the triangle, and carries out interpolation using the increments calculated by the setup engine 7.

The early fragment test program unit 9 compares the depth value of a pixel (source) which is going to be drawn from now on, the depth value being calculated by the rasterizer 8, with the depth value in the destination data (display screen) of a pixel which is previously read out of the pixel cache 5. At this time, if the comparison result shows that the depth value of the pixel which is going to be drawn falls within its limit in which drawing of pixels should be permitted, the early fragment test program unit feeds the data about the pixel which is going to be drawn because it has been assumed to pass the test back to the shader core 6 so that the shader core can continue carrying out the drawing processing. In contrast, unless the comparison result shows that the depth value of the pixel which is going to be drawn does not fall within the limit, because the early fragment test program unit judges that it has failed the test and therefore does not need to draw the pixel, the early fragment test program unit does not output the pixel data to the shader core 6 located therebehind.

Next, the command data distributor 38 reads texture data from the video memory 2A, and transfers them, as well as an instruction code of the shader program about the pixel shader, to the shader cores 6 of the integrated shader pipelines 39-0, 39-1, 39-2, 39-3, and . . . in turn. The shader core 6 carries out the pixel shader process using the pixel information from the command data distributor 38 and the pixel information inputted thereto from the early fragment test program unit 9.

The shader core 6, after carrying out the pixel shader process, then reads the destination data from the frame buffer of the video memory 2A using the command data distributor 38, and carries out an alpha blend process and a raster operation process.

The shader core 6 of each of the integrated shader pipelines 39-0, 39-1, 39-2, 39-3, and . . . temporarily store final pixel data computed by each integrated shader pipeline in the shader cache 3. Then, the final operation value of the pixel data is written from the shader cache 3 into the level 2 cache 40. The pixel data are then transferred to the frame buffer region of the video memory 2A via the level 2 cache 40.

As mentioned above, in accordance with this embodiment 4, the plurality of integrated shader pipelines each of which carries out the vertex shader process and the pixel shader process integratedly are arranged in parallel with one another, and the command data distributor 38 for distributing commands and data to be processed among the plurality of integrated shader pipelines is disposed. Therefore, when the plurality of integrated shader pipelines are of multi-thread type, the image processing device can carry out the vertex shader process and the pixel shader process in parallel, and can improve the throughput of the vertex shader process and that of the pixel shader process. By changing the number of integrated shader pipelines which are arranged in parallel with one another according to the intended purpose of the image processing device, the image processing device can be flexibly and widely suited to a variety of uses from uses for incorporation into apparatus whose hardware scale is limited to high-end uses.

### INDUSTRIAL APPLICABILITY

As mentioned above, the image processing device in accordance with the present invention which can remove the imbalance between the processing load of a vertex shader and that of a pixel shader, and which can make the vertex shader and the pixel shader carry out their processes efficiently is suitable for use in mobile terminal equipment which displays an image, such as a 3D computer graphic image, on a display screen, and whose hardware scale needs to be reduced especially when it is used with being incorporated into the mobile terminal equipment.

1. An image processing device comprising:
a shader processor for carrying out a vertex shader process and a pixel shader process successively;
a rasterizer unit for generating pixel data required for the pixel shader process on a basis of data on which the vertex shader process has been performed by said shader processor; and
a feedback loop for feeding the pixel data outputted from said rasterizer unit back to said shader processor as a target for the pixel shader process which follows the vertex shader process.

2. The image processing device according to claim 1, characterized in that said device includes a fragment test unit disposed on a part of the feedback loop, which extends from the rasterizer unit to the shader processor, for judging whether drawing of the pixel data outputted from said rasterizer unit can be carried out so as to determine whether the feedback of said pixel data to said shader processor can be carried out according to a result of the judgment.

3. The image processing device according to claim 1, characterized in that the shader processor reads or writes data required for the shader process via a cache memory, and reads an instruction code of a shader program.

4. The image processing device according to claim 3, characterized in that said device includes an FIFO disposed on a part of the feedback loop, which extends from the rasterizer unit to the shader processor, for holding the data output from said rasterizer unit, and the cache memory prefetches the data transferred from said rasterizer unit to said FIFO.

5. The image processing device according to claim 1, characterized in that the shader processor also carries out successively shader processes other than the pixel shader process which follows the vertex shader process, and said shader processor executes a shader program of each of the shader processes using a resource specific to the program.

6. The image processing device according to claim 5, characterized in that the shader processor includes program counters for switching among shader programs for every shader process.

7. The image processing device according to claim 1, characterized in that the shader processor includes two or more instruction decoders for decoding an instruction code which specifies an arithmetic operation in arithmetic formats with different bit numbers, two or more computing units having two or more arithmetic units and a conversion unit for converting an arithmetic format, for performing an arithmetic format conversion on either operations by said arithmetic units or results of the operations using said conversion unit so as to compute arithmetic format data corresponding to said each instruction code, a crossbar switch for inputting data required for the shader process and for selecting operation target data for each of said computing units from the input data, and a sequencer for determining the data selection by said crossbar switch and a combination of some of said arithmetic units which will perform data arithmetic operations according to the instruction decoded by said instruction decoders, so as to control the data arithmetic operations by said computing units in the arithmetic format corresponding to each instruction code.

8. The image processing device according to claim 7, characterized in that said device uses an instruction set which consists of instruction codes which specify computing units and the combination of their arithmetic units, and changes a combination format of said instruction set according to a type of an operation instruction in each shader process.

9. An image processing apparatus comprising:
a plurality of image processing devices according to claim 1 which are arranged in parallel with one another;
a video memory for storing data required for each shader process, and a shader program which is to be executed by a shader processor of each of said plurality of image processing devices; and
a command data distributing unit for reading and distributing data stored in said video memory and instruction codes of a shader program according to a process carried out by each of said plurality of image processing devices.
